(19) United States
(12) Patent Application Publication
(10) Pub. No.: US 2013/0110413 A1
(43) Pub. Date: May 2, 2013

(54) ESTIMATING GAS USAGE IN A GAS BURNING DEVICE

(71) Applicants: Brian Michael Schork, Louisville, KY (US); John K. Besore, Prospect, KY (US); Chelsea Rose Miko, Wooster, OH (US); Jonathan Simon Velasco, Miami, FL (US)

(72) Inventors: Brian Michael Schork, Louisville, KY (US); John K. Besore, Prospect, KY (US); Chelsea Rose Miko, Wooster, OH (US); Jonathan Simon Velasco, Miami, FL (US)

(21) Appl. No.: 13/283,287

(22) Filed: Oct. 27, 2011

(51) Int. Cl. G06F 19/00

(52) U.S. Cl. 702/24

(57) ABSTRACT

An apparatus includes at least one transducer that obtains a measurement of one aspect of the combustion process of a gas-burning device. The apparatus also includes a microprocessor to calculate gas usage of the gas-burning device based on the measurement obtained by the at least one transducer. Also included are methods for using the apparatus.

### BACKGROUND OF THE INVENTION

The subject matter disclosed herein relates generally to energy management, and more particularly to energy management of household consumer appliances, as well as other energy consuming devices and/or systems found in the home.

The present disclosure finds particular application to gas-burning devices such as hot water heaters, gas clothes dryers, and furnaces. Additionally, an aspect of the present invention can be implemented within home energy management (HEM) systems, which can aid in reducing energy consumption in homes and buildings. Existing HEMs are commonly placed in one of two general categories: In the first category, the HEM is the form of a special custom configured computer with an integrated display, which communicates with devices in the home and stores data, and also has simple algorithms to enable energy control and reduction. This type of device may also include a keypad for data entry or the display may be a touch screen. In either arrangement, the display, computer and key pad (if used) are formed as a single unit. This single unit is either integrated in a unitary housing, or if the display is not in the same housing, the display and computer are otherwise connected/associated upon delivery from the factory and/or synchronized or tuned to work as a single unit.

In the second category, the HEM is in the form of a low cost router/gateway device in a home that collects information from devices within the home and sends it to a remote server and in return receives control commands from the remote server and transmits them to energy consuming devices in the home. In this category, again, as in the first, the HEM may be a custom configured device including a computer and integrated/associated display (and keypad, if used) designed as a single unit. Alternately, the HEM may be implemented as a home computer such as laptop or desktop operating software to customize the home computer for this use.

Accordingly, HEM systems may comprise a network of energy consuming devices within the home, and may perform the functions of measuring the energy consumption of the entire home/building or individual devices, recording and storing energy consumption information in a database, and also may provide a consumer interface with all energy consuming devices in a home.

Hydrocarbon fueled devices, such as water heaters, gas clothes dryers and furnaces, can present a challenging situation for monitoring energy consumption because such devices do not consume electricity as their primary energy source. Gas hot water heaters burn gas, such as natural gas or propane, to heat water. Typically, the amount of gas used by the hot water heater is not readily ascertainable unless the gas water heater is the only gas-powered appliance in the home. Further, even if the gas water heater is the only gas-powered appliance in the home, the gas consumption of the unit is generally not known to the consumer until a monthly bill is issued for the gas used during the previous month. Consequently, a need exists to reliably determine gas usage of hydrocarbon fueled devices to facilitate attempts to control energy usage of such devices.

### BRIEF DESCRIPTION OF THE INVENTION

As described herein, the exemplary embodiments of the present invention overcome one or more disadvantages known in the art.

One aspect of the present invention relates to a sensor module apparatus comprising at least one transducer that obtains a measurement of one aspect of the combustion process of a gas-burning device; and a microprocessor to calculate gas usage of the gas-burning device based on the measurement obtained by the at least one transducer.

Another aspect relates to a sensor module apparatus comprising at least one transducer that obtains a measurement of one aspect of the combustion process of a gas-burning device; and a radio frequency carrier to link the sensor module to a home energy management system to transmit the measurement of one aspect of the combustion process of a gas-burning device and a time stamp to the home energy management system to calculate gas usage of the gas-burning device based on the measurement obtained by the at least one transducer.

Another aspect relates to a method comprising calculating a running average of temperature data and corresponding time data for a component of a gas-burning device for a given timeframe; calculating a first derivative of the running average data; calculating a second derivative of the running average data; identifying one or more peaks in the second derivative data; identifying one or more valleys in the second derivative data; using the first derivative data to select valley data points among the one or more identified valleys in the second derivative data; subtracting the selected valley data point from the selected peak data point to determine an amount of time of gas usage; and using the amount of time of gas usage to calculate a volume of gas used based on one or more parameters of the gas-burning device.

Another aspect relates to a method comprising collecting temperature data and corresponding time data for a component of a gas-burning device; analyzing the temperature data to determine a time at which the gas-burning device begins burning gas and a time at which the gas-burning device ends burning gas; calculating a time duration of gas consumption by the gas-burning device based on the time at which the gas-burning device begins burning gas and the time at which the gas-burning device ends burning gas; calculating an amount of energy used during the calculated time duration of gas consumption based on the time duration and one or more parameters of the gas-burning device; and calculating a volume of gas used during the time duration of gas consumption based on the calculated amount of energy used and one or more parameters of the gas-burning device.

Another aspect of the invention relates to a system for determining burner duration of an appliance having a gas burner. The system includes a temperature sensor responsive to temperature of a structure of the appliance heated by the gas burner, and a processor coupled to a memory, and operatively connected to the temperature sensor to receive and store temperature data from the sensor and process the data to detect turning on of the gas burner and turning off of the gas burner and to determine a duration of time between the turning on and turning off of the burner.

Yet another aspect of the present invention relates to a method for determining gas consumed by an appliance having a gas burner. The method comprises identifying turning on times of the burner; identifying turning off times of the burner; determining a burner duration of time the burner is on time by determining a time lapse between the turning on time and the turning off time; and calculating an amount of gas consumed as a function of the duration of time the burner is on.

Use of transducers in accordance with aspects of the present invention avoids the need for a consumer or a plumber (water heater installer) to break the gas line to install a gas flow meter in the line to facilitate the monitoring of gas flow of the water heater or other gas consuming appliance. These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 presents a schematic diagram of an exemplary hydrocarbon-fueled hot water heater, in accordance with a non-limiting exemplary embodiment of the invention;

FIG. 2 presents a schematic diagram of an exemplary hydrocarbon-fueled hot water heater, in accordance with a non-limiting exemplary embodiment of the invention;

FIG. 3 presents a schematic diagram of an exemplary hydrocarbon-fueled hot water heater, in accordance with a non-limiting exemplary embodiment of the invention;

FIG. 4 presents a data flow diagram for estimating gas usage in a gas burning device, in accordance with a non-limiting exemplary embodiment of the invention;

FIG. 5 presents a data flow diagram for estimating gas usage in a gas burning device, in accordance with a non-limiting exemplary embodiment of the invention; and

FIG. 6 is a block diagram of an exemplary computer system useful in connection with one or more embodiments of the invention.

### DETAILED DESCRIPTION OF THE EXEMPLARY EMBODIMENTS OF THE INVENTION

Traditionally, the amount of fuel burned by a conventional hydrocarbon-fueled water heater has not been readily ascertainable. Accordingly, consumers typically are not aware of the energy costs associated with hot water usage. As described herein, one or more embodiments of the invention include techniques and apparatus for estimating gas usage by a gas-burning device using indirect methods not including direct gas monitoring. An aspect of this invention includes a methodology for determining the consumption of natural gas for any natural gas appliance that utilizes a fixed flow one stage burner (for example, a gas water heater, gas clothes dryer or gas furnace) without having to break the gas line to install a sensor.

In fixed orifice burners, such as are typically used in gas water heaters, gas furnaces and gas clothes dryers, the natural gas flows at a constant rate. An aspect of the invention is to determine how long a burner is on, and use that information to calculate how much gas the burner consumed. The techniques detailed herein include use of at least one non-invasive transducer to monitor one or more physical end results, e.g., combustion side-effects or system characteristics, that occur as a result of an appliance consuming and combusting hydrocarbon fuel, to detect the turning on and turning off of a burner, hereinafter referred to as turn on and turn off events, respectively.

One parameter which can be monitored to detect turn on and turn off events is the temperature of the exhaust gases, or the temperature of a structural surface affected by the heat generated by the burner. The change in temperature that occurs when the burner ignites and extinguishes can be fairly accurately correlated with the flow of gas in the burner and then, in turn, be converted to the actual cubic feet of hydrocarbon fuel used by knowing the time that the burner is flowing gas. For example, a temperature probe can be attached directly to the surface of the vent pipe of the water heater. Likewise, the probe can be attached to any physical location of the water heater that has a temperature profile that will respond to the turning on and turning off of the gas burner, such as location proximate the burner. The attachment means can include, but are not limited to, the following: an adhesively attached temperature probe, a magnetically attached temperature probe, or a probe strapped to the pipe with a clamp or a zip tie or other suitable means well known to those skilled in the art.

Alternate methods to detect burner turn on and turn off events by monitoring variables other than temperature can include, for example, measuring the voltage change in the gas valve through inductive coupling or direct voltage measurement, measuring the flow of gas in the pipe with non-invasive sensors well known in the industry such as ultrasonic, laser, etc., measuring the on/off cycle of a fan unit on a forced exhaust (inductively or direct), or by measuring the flow of exhaust gas with a flow eter in or outside the vent pipe. Alternative transducers can include, by way of example, flow meters, accelerometers, microphones, etc.

As noted above, the use of temperature probes or other transducers in accordance with the aspects of the present invention to estimate gas usage facilitates retrofitting existing gas burning appliance installations to measure gas usage by avoiding the need for a consumer or a plumber (water heater installer) to break the gas line to install a gas flow meter in the line to facilitate the monitoring of gas flow of the water heater.

The transducer data collected can be processed and the information can be transmitted to a home energy management module and reported back to the consumer. Alternatively, the data collected can be transmitted to a home energy management module and processed by the module for display to the consumer.

As further detailed in connection with the embodiments described herein, the transducer of the illustrative embodiments comprises a sensor such as a thermocouple (or similar device) placed on the water heater in one or more locations, for example, inside the burner box, in the flue gas stream, and/or on a surface of the exhaust pipe. It is to be understood however, that the sensor can be placed at any location on the water heater that experiences a detectable change in temperature in response to burner turn on and burner turn off events. The location that experiences the most rapid unambiguously detectable change in response to a burner turn on or turn off event will be the most optimal location for the sensing transducer.

As detailed herein, aspects of the present invention can be implemented with any fixed orifice or constant flow rate gas burning device, but by way of illustration, a number of the figures present aspects of the invention within the context of a hot water heater.

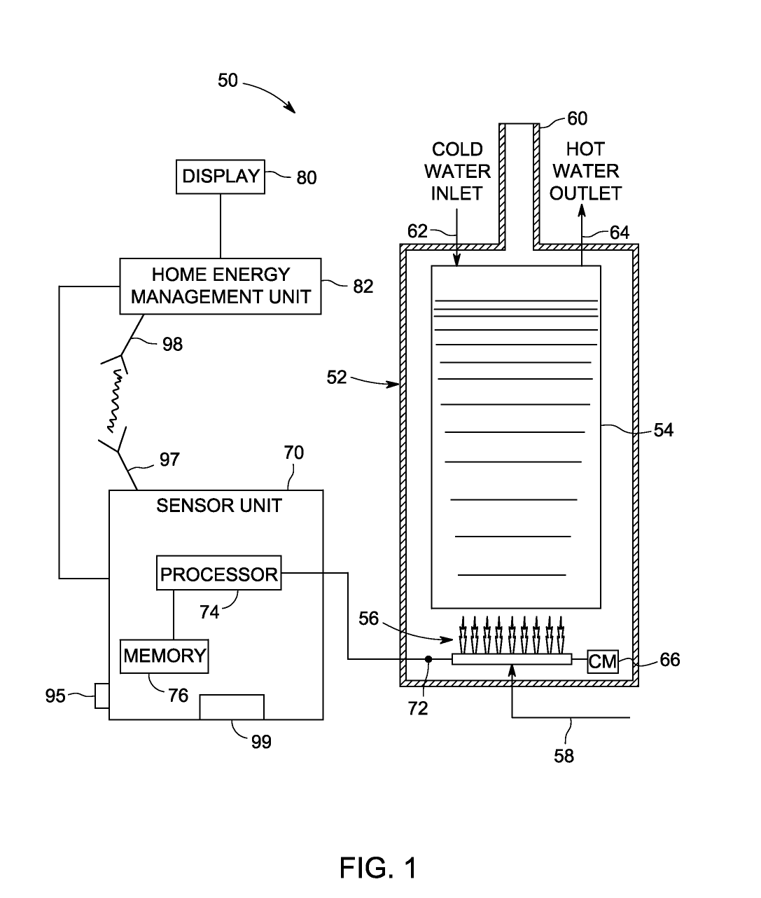

Turning to FIG. 1, an exemplary hot water heater system 50 is illustrated. The hot water heater system 50 includes a hydrocarbon-fueled hot water heater 52 having a reservoir 54 and a burner 56 for applying heat to a volume of water. The burner 56 burns fuel supplied thereto from a fuel supply 58. The burner 56 can be housed, for example, within a burner box (not pictured). A burner box can additionally include a pilot window for convenience. The hot water heater system can additionally include a rating plate (not pictured). Hot exhaust gases are discharged via the vent stack 60. Cold water is admitted to the water heater 52 via inlet 62, and hot water is discharged via hot water outlet 64. A control module 66 controls operation of the burner 56. Such a control module may typically include a thermocouple, one or more valves, and a pilot or other ignition source for igniting the burner. As will be appreciated, the control module 66 operates to activate the burner 56 to apply heat to a volume of water to heat the water to a desired set point.

In the embodiment of FIG. 1, a sensor module (or unit) 70 is provided for sensing the temperature of a physical location of the appliance which fluctuates in temperature in response to the turn on and turn off events for the burner 56. The sensor module 70 can be attached to the outer shell of the heater 52 (for example, magnetically attached or attached via adhesive) or near thereto. In the illustrated embodiment, the sensor unit 70 includes a processor 74 and a memory 76, and is connected to a sensor 72 positioned to sense the temperature proximate the burner 56. The processor 74 is in communication with the sensor 72 and a memory 76 for storing data related to the sensed temperature, which the processor 74 uses for calculating gas usage as described herein. In this embodiment, processor 74 samples the output of the sensor 72 at fixed time intervals to collect temperature versus time data which is stored in memory 76. The temperature versus time data can then be processed to determine the “on times” of the burner. Additionally, sensor unit 70 can include a battery 99 and/or a power supply 95 (for example, a DC power supply). The sensor unit can additionally include a communication module to send information about battery voltage to a home energy manager to trigger an alert when the battery needs to be replaced.

In the illustrative embodiment of FIG. 1, the sensor 72 comprises a thermistor or thermocouple to collect temperature data which is processed as hereinafter described to detect the occurrence of turn on and turn off events for the burner. However, it is to be understood that the sensor could include one or more of the following in lieu of the thermistor or thermocouple to detect the turn on and turn off events for the burner:
an infrared (IR) detector, heat detector, or other transducer that can detect a flame in the water heater burner area. The start and stop times of the flame can be sent to the processor for calculating the “total on time” between two points in time.
a thermoelectric device that generates a voltage proportional to the temperature increase near the burner. By monitoring this voltage and/or sending the signal to the processor, the processor can use such information to calculate burner on time.
an acoustic or vibration detection device in the burner area can be used to detect the presence of combustion in the burner area to identify the “on” and “off” conditions of the burner. For example, a microphone can be tuned to detect burner noise. An accelerometer can be used to detect vibrations resulting from the combustion process.

As depicted in FIG. 1, the sensor unit 70 collects temperature data for a sensor location proximate the burner box, e.g., in the burner box, or a surface of the burner box structure, versus time. The sensor unit 70 carries out an algorithm that processes temperature data and calculates first and second derivative data thereof and uses this data to determine the burner on/off time (as detailed further herein). Additionally, the sensor unit 70 back-calculates the gas used for a specific timeframe (for example, 24 hours).

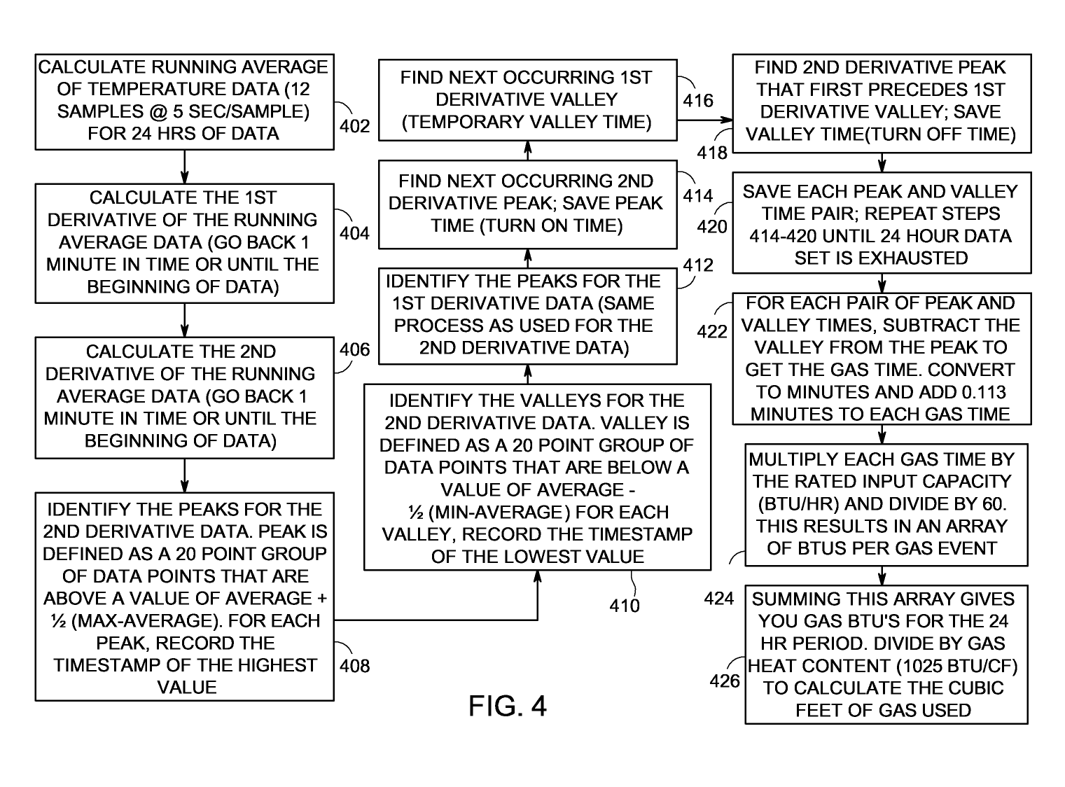

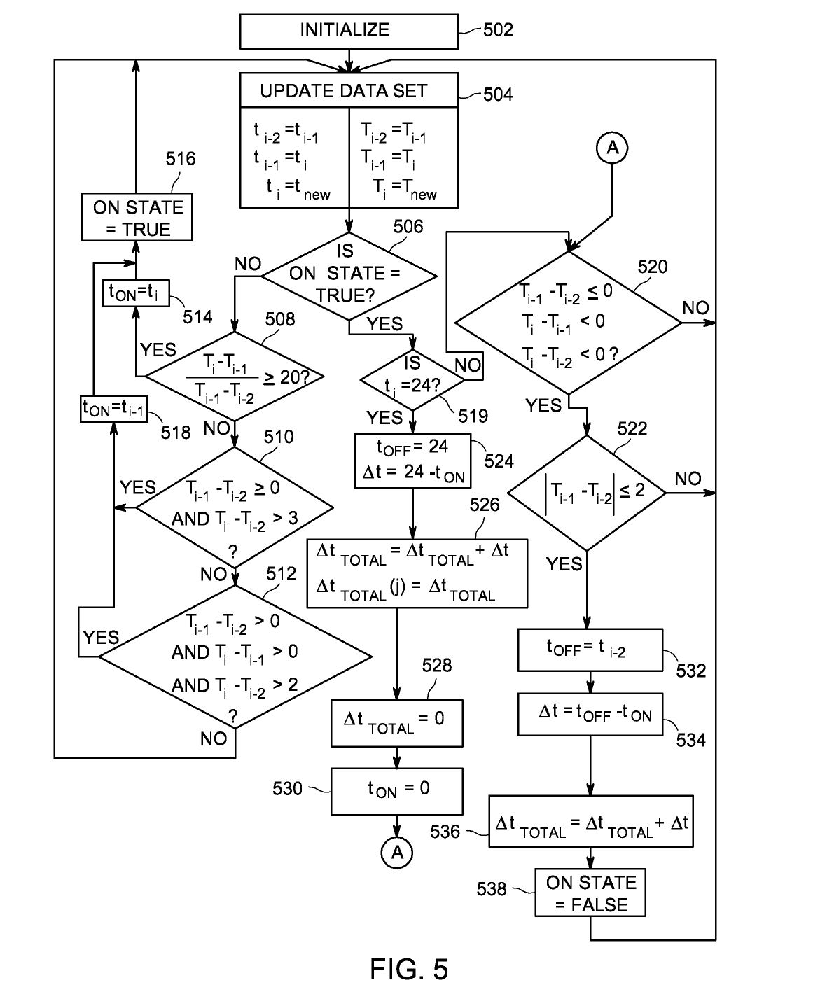

Because the burner in the embodiment of FIG. 1 is a fixed orifice burner which operates at a constant rate, as is the case with burners for most hydrocarbon (“gas fired”) water heaters and furnaces, a reasonably accurate estimate of the amount of gas consumed over a predetermined period of time, for example a 24 hour period, can be calculated based on the cumulative amount of time the burner is on during the predetermined period of time. The intervals of time that the burner is on can be determined by detecting the turning on and turning off of the burner and recording the time elapsed between each turn on and turn off event. Knowing the cumulative on time for the burner, the rated capacity of the burner is then used to estimate the amount of fuel that is consumed. Such an estimation method takes the form of: gas consumed=time on (minutes)*flow rate (cfm)=x cubic feet consumed, where flow rate=burner capacity (BTU)/gross heat of combustion of natural gas. The actual gross heat of combustion for natural gas can vary geographically and over time. The actual then prevailing value for a particular region if known, could be used; however, a value of 1025 BTU/ft³ has been used by the natural gas industry as a reliable average value (the value would be different for propane). This value is used in the illustrative embodiments herein described. To further optimize the accuracy, an efficiency factor that relates to the water heater efficiency could be applied to the equation used to calculate the flow rate. This would increase the flow rate of gas for a given capacity. Typically, there are several assumptions made in order to implement this method: 1) the orifices that flow gas are flowing at the rated capacity, 2) the line pressure of the gas supply is within specifications, and 3) ignoring the pilot gas consumption (for those units that may have a pilot and a thermocouple) does not significantly impact the estimation. If the water heater incorporates a gas-fueled pilot light, the system can invoke an adder that would use a default value for the pilot gas consumption. This would enhance the accuracy of the gas usage algorithm in determining the total gas usage. Also, most gas water heaters use similar amounts of gas for a pilot system, so a default value could be used for heaters that employ a pilot light. Illustrative techniques for processing the temperature versus time data to identify the turn on and turn off events will be hereinafter described with reference to FIGS. 4 and 5.

Once the burner “on time” and gas usage is calculated, the energy usage in terms of volume, cost, etc. can be displayed to a user on a display 80. In such an embodiment, the display can be associated with the sensor unit 70 and/or a home energy management (HEM) unit 82. Both the sensor unit 70 and the display 80 can be provided integrally with the water heater 52, or as add-on components mounted thereto. Further, as additionally described herein, information from the sensor unit 70 can be relayed to a home energy manager 82 for use in HEM algorithms. This relay of information can be performed via the use of an antenna 97 incorporated into the sensor unit 70 as well as an antenna 98 incorporated into the HEM unit 82 (and communication therebetween). This communication can also be accomplished by utilizing a technology known as PLC (Power line Communications), which is well known to those skilled in data communications in the Utility industry. As noted, in some embodiments, the display 80 can be associated with the HEM thus obviating the need for a dedicated display to be provided to display the energy usage details at the hot water heater itself.

The HEM unit 82 can provide input to the sensor unit 70 such as the current time as well as user input of burner ratings and localized gross heat of combustion of natural gas values obtained from the local gas utility (or default values in the absence thereof). Additionally, in one embodiment of the invention, the connection between the HEM unit 82 and the sensor unit 70 can be hard-wired.

A hot water heater system as detailed herein can additionally include a user interface in lieu of or in addition to a link to the HEM to enable the user to program the controller. The user interface can include one or more user inputs and a display for displaying data and/or settings to the user. Such user interface can be associated with the controller and/or water heater, or can be a separate device that is configured to communicate with the controller. For example, the user interface could be a display and keypad mounted to the hot water heater. Alternatively, the user interface could be a personal computer or a cell phone configured to communicate with the controller.

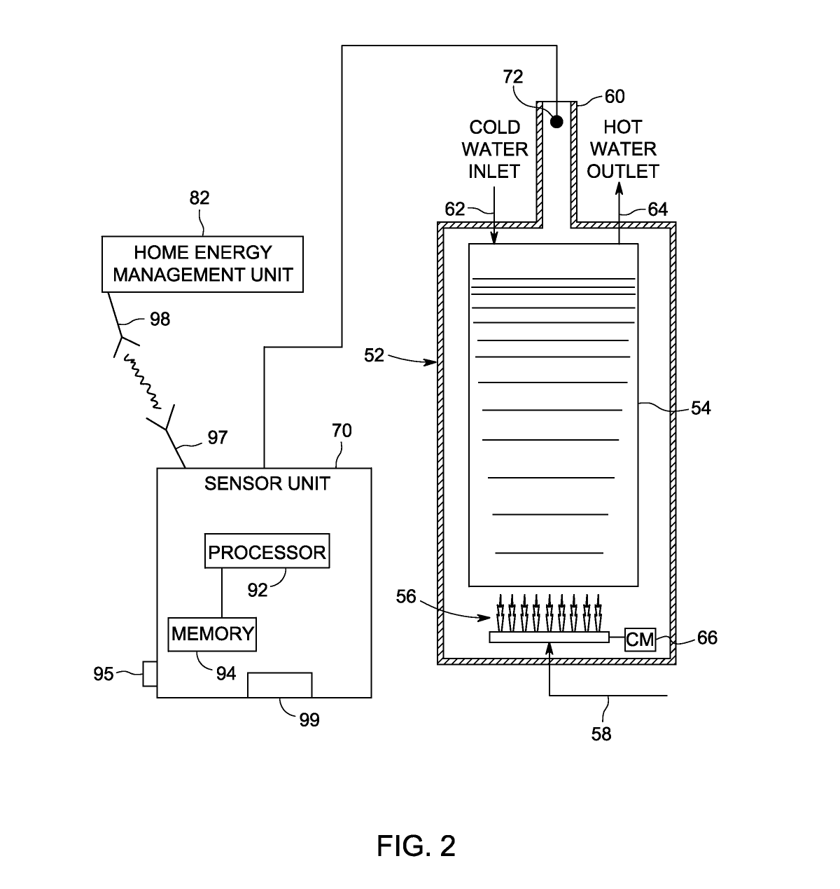

Turning to FIG. 2, another exemplary hot water heater system is illustrated. The hot water heater system includes a hydrocarbon-fueled hot water heater 52 having a reservoir 54 and a burner 56 for applying heat to a volume of water. The burner 56 burns fuel supplied thereto from a fuel supply 58. The burner 56 can be housed, for example, within a burner box (not pictured). A burner box can additionally include a pilot window for convenience. The hot water heater system can additionally include a rating plate (not pictured). Hot exhaust gases are discharged via the vent stack 60. Cold water is admitted to the water heater 52 via inlet 62, and hot water is discharged via hot water outlet 64. A control module 66 controls the burner.

In accordance with the present disclosure, a sensor module (or unit) 70 is provided for sensing the temperature versus time profile of the location being sensed. The sensor module 70 can be attached to the outer shell of the heater 52 (for example, magnetically attached or attached via adhesive) or near thereto. In the illustrated embodiment, the sensor unit 70 includes a processor 92 and a memory 94, and is connected to a sensor 72. In this embodiment, sensor 72 is a thermistor or thermocouple or other temperature sensing transducer located proximate the vent stack 60 to sense the temperature of the exhaust gases. The processor 92 is in communication with the sensor 72 and a memory 94 for storing data related to the burner on time, which the processor 92 uses for calculating gas usage as described herein. More specifically, processor 92 samples the output of the sensor 72 at fixed time intervals to collect temperature versus time data which is stored in memory 94. The temperature versus time data can then be processed to detect the turn on times and turn off times of the burner and determine the duration of the “on times” of the burner.

Additionally, sensor unit 70 can include a battery 99 and/or a power supply 95 (for example, a DC power supply).

In the illustrative embodiment of FIG. 2, as above described, sensor 72 is a temperature transducer to collect temperature data which is processed as hereinafter described to detect the turning on and off of the burner. However, it is to be understood that the sensor could one or more of the following in lieu of the temperature transducer to detect the turn on and turn off events for the burner:
a flow transducer within the vent stack 60 to detect the flow of expelled gases to give an indication of “burner on.” The probe of such sensor would likely need to be tolerant of high temperature gases flowing.
a strain gauge on the surface of the vent pipe to detect the strain rate change due to the expansion caused by the hot gases in the vent stack 60. As before, the strain gauge likely would need to be tolerant of high temperatures.
a gas sensor, such as a carbon monoxide (CO) sensor, in the vent stack 60 to detect the presence of carbon monoxide, or any other inert gas sensor, that would be present in the exhaust gases from the combustion process to capture the on and off conditions of the burner.

Further, as additionally described herein, information from the sensor unit 70 can be relayed to a home energy manager 82 for use in HEM algorithms. This relay of information can be performed via the use of an antenna 97 incorporated into the sensor unit 70 as well as an antenna 98 incorporated into the HEM unit 82 (and communication therebetween).

The HEM unit 82 provides input to the sensor unit 70 such as the current time as well as user input of burner ratings and localized gross heat of combustion of natural gas values obtained from the local gas utility (or default values in the absence thereof). Additionally, in one embodiments of the invention, the connection between the HEM unit 82 and the sensor unit 70 can be hard-wired.

In the illustrative embodiment of FIG. 2, the sensor unit 70 collects temperature data for stack or air stream versus time. The sensor unit 70 carries out an algorithm that processes temperature data and calculates first and second derivative data thereof and uses this data to determine the burner on/off time (as detailed further herein). Additionally, the sensor unit 70 back-calculates the gas used for a specific timeframe (for example, 24 hours), and the sensor unit also transmits the usage data to the HEM unit 82. The HEM unit 82 records data for a selected period of time (for example, 24 hours).

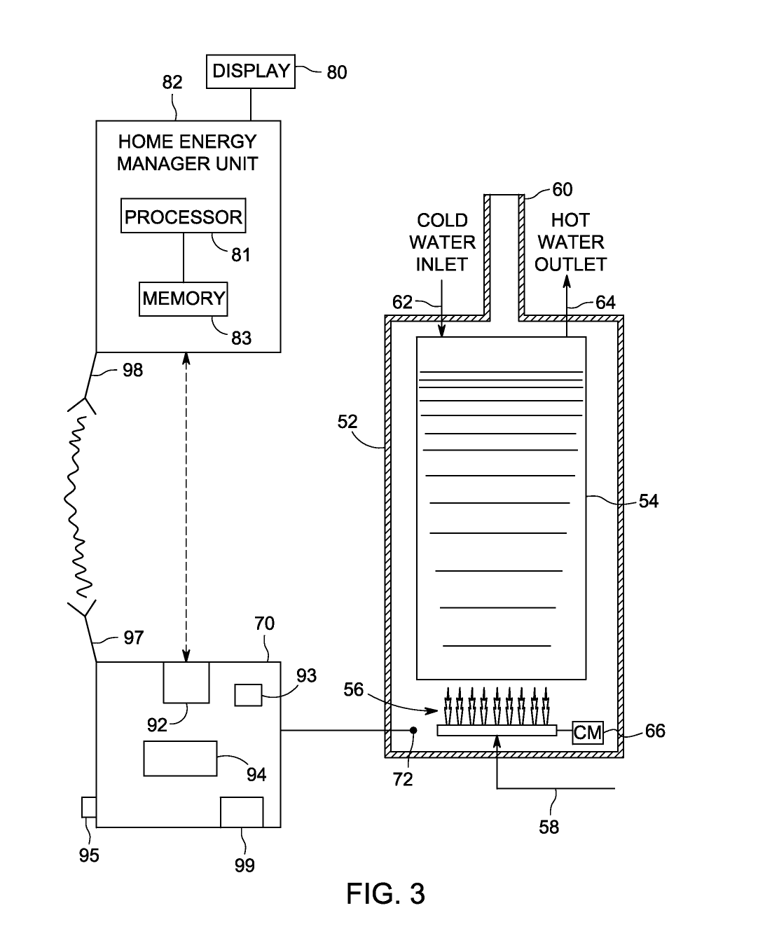

Turning to FIG. 3, yet another exemplary hot water heater system in accordance with the present disclosure is illustrated. This embodiment is substantially similar to the embodiment of FIG. 1, except that the data used to determine the amount of gas consumed is transmitted to the HEM and the HEM rather than the sensor module processes the data. In this embodiment, the hot water heater system includes a hydrocarbon-fueled hot water heater 52 having a reservoir 54 and a burner 56 for applying heat to a volume of water. The burner 56 burns fuel supplied thereto from a fuel supply 58. The burner 56 can be housed, for example, within a burner box (not pictured). A burner box can additionally include a pilot window for convenience. The hot water heater system can additionally include a rating plate (not pictured). Hot exhaust gases are discharged via the vent stack 60. Cold water is admitted to the water heater 52 via inlet 62, and hot water is discharged via hot water outlet 64. A control module 66 controls the burner.

In the embodiment depicted in FIG. 3, a sensor 72 is provided on or adjacent the burner (or burner box) 56 of the hot water heater and is configured to detect physical and/or chemical changes that that characterize the turning on or turning off of the burner 56. The sensor communicates data to a sensor module (or unit) 70 that includes a processor 92, a radio 93 and memory 94. The sensor unit 70 also includes a battery 99 and/or a power supply 95 (for example, a DC power supply). In this embodiment, the sensor unit transmits temperature data to the HEM unit 82 for use in HEM algorithms. The HEM unit 82, which includes a processor 81 and memory 83 performs all calculations and a user inputs burner capacity parameters into the HEM unit (or defaults are entered). The HEM unit 82 provides input to the sensor unit 70 such as the current time. Additionally, the connection between the HEM unit 82 and the sensor unit 70 can be hard-wired. This relay of infoiination can be performed via the use of an antenna 97 incorporated into the sensor unit 70 as well as an antenna 98 incorporated into the HEM unit 82 (and communication therebetween). In this embodiment, the display 80 can be associated with the HEM thus obviating the need for a dedicated display to be provided to display the energy usage details at the hot water heater itself.

Once the burner “on time” is calculated, the energy usage in terms of volume, cost, etc. can be displayed to a user on a display 80.

As noted herein, assumptions can be made about a given water heater such as, the BTU/hr rating of the burner, the efficiency of the burner, and the energy content of the natural gas to make these calculations. In many cases, the homeowner can obtain these inputs from the water heater manufacturer or from the energy label to improve the accuracy of the calculations. If such inputs are not provided, one or more embodiments of the invention can include inputting assumed values based on the age and/or efficiency of the water heater, assuming that the homeowner will input these very basic parameters.

By way of example, code for the algorithms detailed herein can be embodied on a chip. Additionally, a sensor module (as described herein) can be independently implemented in a home energy management system. In one or more embodiments of the invention, the module includes a microprocessor containing the software for carrying out the techniques detailed herein, and the module would be capable of sending gas usage data up to the home energy manager by way of a radio. In another aspect of the invention, the module can send the temperature data in a stream (with a time stamp) to the home energy manager on a continuous basis, and then the home energy manager utilizes this data and performs the calculations of gas usage. The module can also have a power supply or a battery (including the ability to send information about the voltage to the home energy manager to provide an alert when the battery needs to be replaced).

FIG. 4 presents a data flow diagram for processing the collected temperature versus time data to estimate gas usage in a gas burning device, in accordance with a non-limiting exemplary embodiment of the invention. In this example embodiment, data is collected for successive 24 hour periods beginning at 12:00 am. The data for each 24 hour period is then processed to detect turn on and turn off events that occurred during the 24 hour period, determine the time lapse between successive turn on and turn off events, that is, the duration of each on period for the burner, that occurred during that 24 hour period and finally to calculate from that information, the amount of gas consumed during that 24 hour period. The embodiments herein described are configured to collect, process and display data for a time period of 24 hours. Other time periods could be similarly employed.

It has been empirically determined that the peaks and valleys of the second derivative of the temperature versus time data provide reasonably accurate markers of the burner turn on and turn off events, respectively. However, the valleys may also be prone to a valley occurring between the peak marking the turn on event and the valley marking the burner turn off event as the rate of increase in the temperature slows down. The peaks and valleys of the first derivative data also mark the burner turn on and turn off events, but with less precision than the second derivative data. However, the first derivative data is not prone to any intermediate valleys. In the embodiment of the process herein described, the valleys of the first derivative data are used in combination with the second derivative valley data to avoid the false second derivative valleys. More particularly, the first derivative valleys are used to approximately mark the turn off events, then the second derivative valley first preceding in time each first derivative valley is identified and the time of that second derivative valley is used as the end time, that is, the time of the turn off event.

In FIG. 4, Step 402 includes calculating a running average of temperature data (for example, 12 samples at five seconds per sample for 24 hours of data). Step 404 includes calculating the first derivative of the running average data (wherein derivative equals the slope of the data). For this step, the calculation can include going back one minute in time or until the beginning of data. To calculate the first derivative, consider points in the data that are a determined time or distance apart (for example, one minute apart) and calculate the slope (rise over run) of those two points. Step 406 includes calculating the second derivative of the running average data. For this step, the calculation can also include going back one minute in time or until the beginning of data. To calculate the second derivative, a similar technique is used as with the first derivative data; that is, the slope (rise over run) is calculated points in the first derivative data that are a determined time or distance apart (for example, one minute apart).

Step 408 includes identifying the peaks for the second derivative data. A peak is defined as a group of data points (for example, a group of twenty consecutive points of data) that is above a peak threshold value. The peak threshold value is established using the maximum value (Max.) and the average value (Average) of the referenced group of data points, which in this embodiment is 24 hours of data. These values are used to establish a threshold value for identifying peaks in the data using the equation: Peak Threshold=Average+½(Max−Average). For each peak, the timestamp is recorded for the highest value in each group of data that exceeds the Peak Threshold. Step 410 includes identifying the valleys for the second derivative data. A valley is defined as a group of data points (for example, a group of twenty consecutive points of data) that is below a valley threshold value. The valley threshold value is similarly determined from the data set (for example, 24 hours of data) using the equation: Valley Threshold=Average−½(Min−Average), where Min is the lowest data point in the referenced group of data points. For each valley, the timestamp is recorded for the lowest value in each group of data that is less than the Valley Threshold. Step 412 includes identifying the peaks for the first derivative data (for example, via the same process as used for the second derivative data).

As the peak and valley data is being processed, it is processed in time order (for example, from midnight to midnight, or 0:00 hours to 23:59 hours). Step 414 includes, starting at time zero, determining the time of the next occurring second derivative peak, which marks the time of a turn on event, that is, the beginning of a burner on period. Step 416 includes determining the time of the next occurring first derivative valley to provide a temporary valley time. Step 418 includes determining the time of the 2^{nd} derivative valley that immediately precedes in time, the first derivative valley identified in Step 416. The time of this second derivative valley marks the time of a turn off event, corresponding to the end of the burner on period. Step 420 includes storing the peak and valley times in respective arrays and returning to Step 414 to repeat Steps 414-420 until the entire 24 hour data set has been processed.

Step 422 includes, for each pair of peak and valley times, subtracting the valley time from the peak time to obtain the gas usage time. This value can be converted to minutes. Further, in one aspect of the invention, 0.113 minutes can be added to each gas usage time. The factor of 0.113 was arrived at through empirical calculation on test data. This is a function of the temperature sensing device location and thermal mass. It can be viewed as a correction factor that would be empirically determined for the location of the temperature sensing device on a particular style of gas-using appliance. Step 424 includes multiplying each gas usage time by the rated input capacity of the burner (BTU/hr) and dividing the resulting value by 60, which results in an array of BTUs per gas usage event. Step 426 includes summing this array to provide gas BTUs for the time period (for example, the 24 hour time period noted in this example). This value is then divided by the gas heat content (for example, 1025 BTU/CF) to calculate the cubic feet of gas used.

FIG. 5 presents a flow diagram for estimating gas usage in a gas burning device, in accordance with a second or alternate non-limiting exemplary embodiment of the invention. This embodiment is particularly accurate in detecting the time of turn on events, but a bit less accurate than the embodiment of FIG. 4 in detecting the times of turn off events. However, it has the advantage of requiring less processing time and resources than the mathematical model of FIG. 4, Step 502 is executed when the heating system is initially turned on, such as at installation of the system, or on restoration of power following a power outage, etc. The On State flag is set to equal False, signifying the burner has not yet turned on. The algorithm is configured to sample the time of day (using a 24 hour clock and sample the temperature sensor to collect a pair of data points, comprising a time t, and a temperature T every 5 seconds. The turn on and turn off detection process uses the three most recent data pairs. The most recent pair is designated (tᵢ, Tᵢ) the next preceding pair is (tᵢ₋₁, Tᵢ₋₁) and the oldest pair is designated (tᵢ₋₂, Tᵢ₋₂). As part of the initialization step, the first ten seconds are used to populate the three set data structure before cycling through the rest of the algorithm. At time t=0, the first data pair (t_{new}, T_{new}) is collected and the data set is updated by setting tᵢ=t_{new} and Ti=T_{new}. Five seconds later the second data set is collected and the data set is updated by setting tᵢ₋₁ equal to the old tᵢ and setting tᵢ=t_{new}. Five seconds later the third data set is collected and the data set is updated by setting tᵢ₋₂ equal to the old tᵢ₋₁, setting tᵢ₋₁ equal to the old tᵢ and setting t₁=t_{new}. On collecting each subsequent data pair, data set is updated at step 504, eliminating the oldest pair and adding the new pair (that is, each new data entry becomes a new tᵢ and Tᵢ, respectively, the previous tᵢ₋ and Tᵢ₋, become the new tᵢ₋₁ and Tᵢ₋₁, and the previous tᵢ₋₁ and Tᵢ₋₁, become the new tᵢ₋₂ and Tᵢ₋₂)

Following the updating of the data set, Inquiry 506 checks the ON State of the burner. The ON State is a flag which is set to True when a turn on event is detected and set to False when a turn off event is detected. As above described, during the initialization phase the ON State is set to False and it will remain False until a turn on event is detected. As such, on the first pass through the algorithm, the process will be directed to the path comprising decision blocks 508, 510 and 512. Each of these decision blocks represents a condition or set of conditions that are evaluated to detect a turn on event. If any one of these sets of conditions is satisfied, a turn on event is indicated.

Decision block 508 evaluates the condition

$$\frac{{T}_{i} - {T}_{i - 1}}{{T}_{i - 1} - {T}_{i - 2}} \geq 20.$$

This condition is particularly effective to identify turn on events for burner systems such as furnaces and high efficiency water heaters. In such systems, the change in temperature when the burner is turned on can be so quick that a ratio of the slopes will serve to detect the turn on event. Because a steady sampling rate is being used, even though the conditions are expressed in temperature terms, slope changes are implicit in the calculations. In general terms, because raw data is being used to perform this procedure, some ripple and therefore oscillation may be encountered in the calculation of slopes. Based on empirical data collected from furnaces, in the embodiment depicted in FIG. 5, the condition requires that temperature be rising fast enough that the ratio of the difference between the latest sample and the prior value to difference between the prior value and the next prior value be 20 or greater to avoid a false trigger. Values other than 20 could be similarly employed and, for optimum performance, should be empirically determined for the particular system design. Turning again to decision block 508, if this threshold is exceeded, the burner will be considered as having been turned on. So, when the condition at 508 is satisfied, tₒₙ is set equal to tᵢ at step 514, signifying that a turn on event occurred at time tᵢ and the ON State flag is set to True at step 516 and the process returns to step 504 to collect the next data pair.

This ratio comparison works well in systems like furnaces and high efficiency water heaters because of the rapid change in slopes that occurs in such systems. However, this ratio approach is less effective in less efficient systems like standard water heaters because in such a short time frame (15 seconds for 3 data points) the ratio difference may not be high enough to be distinguishable from the raw data ripple effects. So the algorithm includes additional conditions for detecting turn on events in less efficient systems. These conditions are evaluated in decision blocks 510 and 512. If the condition of decision block 508 is not satisfied, decision blocks 510 and 512 evaluate other sets of conditions which if satisfied indicate a turn on event. These conditions also look at changes in slope of the temperature data, but are more effective for standard water heaters. Decision block 510 evaluates the set of conditions

$${T}_{i - 1} - {T}_{i - 2} \geq 0$$

$${T}_{i} - {T}_{i - 2} > 3.$$

The condition Tᵢ₋₁−Tᵢ₋₂≧0 indicates that the slope is zero between those two points. If a progression goes from a flat slope state into a rising slope state, it needs to be verified that the device is indeed on. Here, again, there can be a ripple of the raw data. Satisfaction of the condition Tᵢ₋₁−Tᵢ₋₂>3 is required in this embodiment to reduce sensitivity to false triggers. The value “3” in step 510 represents a change in slope of approximately 17 degrees from the horizontal axis (atan( 3/10)=16.7). The value 3 is selected for the embodiment of FIG. 5, but other values could be similarly employed.

When the conditions evaluated in decision block 510 are satisfied, the time tᵢ₋₁ for the three point data set that initially satisfies the condition becomes the turn on time, tₒₙ, as noted in step 518, where tₒₙ=tᵢ₋₁. If the conditions evaluated at decision block 510 are not satisfied, Decision block 512, evaluates the conditions

$${T}_{i - 1} - {T}_{i - 2} > 0$$

$${T}_{i} - {T}_{i - 1} > 0$$

$${T}_{i} - {T}_{i - 2} > 2.$$

In this case, the threshold does not need to be as high. It is easier to reliably detect a turn on event if there is a rising slope from pointᵢ₋₂ to pointᵢ₋₁ and from point to point Using the same concept described in connection with block 508, the threshold value “1” represents a change in slope of approximately 6 degrees from the horizontal axis (atan( 1/10)=5.7). When the aforementioned associated point to point slope conditions are satisfied, a rise of approximately 6 degrees is sufficient to avoid a false trigger.

When a three point data set initially satisfies the conditions of decision block 512, tₒₙ is set equal to tᵢ₋₁ as noted at step 518. When a turn on event is detected as a result of satisfying conditions 510 or 512, the on time, tₒₙ, is set to tᵢ₋₁ rather than tᵢ to account for the time lag associated with use of these conditions to detect the turn on event.

As was the case with decision block 508, if either conditions 510 or 512 are satisfied, a turn on event is detected and the ON Sate is set to True at Step 516 and the process returns to step 504 to update the data set. If none of the conditions of decision blocks 508, 510 or 512 are satisfied, the ON State remains False and the process returns to Step 504. Decision block 506 will continue to direct the process to decision block 508 path as long as the ON State flag remains false; that is, until a turn on event is identified. When the ON State flag is True, decision block 506 directs the process to the path comprising decision blocks 519, 520, and 522 to detect the next turn off event. The algorithm (depicted in the example embodiment in FIG. 5) identifies turn on and turn off events throughout the day (24 hour period). If the day ends while the device was on, from the time tₒₙ until hour 24 will be included in that day while a new loop will be started for the next day.

Decision block 519 determines if the 24 hour period times out during a burner on period in order to facilitate the transition of data collection and processing from the expiring 24 hour period to the new 24 hour period. If tᵢ equals 24, t_{off}, is set to 24, and the final Δt, that is the duration of the final on period, for the ending 24 hour period is calculated as 24−tₒₙ (Step 524) this value of Δt is added to the cumulate Total Δt for the expiring 24 hour period to finalize the total on time for that 24 hour period, (Step 526). The Total Δt variable for the new 24 hour period is set to zero (Step 528), tₒₙ is set to zero hours, (Step 530) and the process proceeds to decision Block 520 to evaluate conditions to detect a turn off event. Referring again briefly to decision block 519, if the 24 hour clock has not timed out, the process simply continues to decision block 520.

Decision block 520 looks for slope changes in the data set indicative of a turn off event. In particular, block 520 looks for satisfaction of the following conditions:

$${T}_{i - 1} - {T}_{i - 2} \leq 0$$

$${T}_{i} - {T}_{i - 1} < 0$$

$${T}_{i} - {T}_{i - 2} < 0.$$

To satisfy these conditions, the slope needs to be either starting at negative followed by another negative slope, or starting from a slope=0 dropping to a negative slope. If these conditions are met, decision block 522 looks for satisfaction of the following condition: |Tᵢ₋₁−Tᵢ₋₂|≦2. This condition requires a temperature drop threshold of two degrees, which is considered a significant drop in slope magnitude. If conditions of decision block 520 and 522 are both satisfied, a turn off event is signified as having occurred at tᵢ₋₂ and Step 532 sets t_{off}=tᵢ₋₂. Having detected a turn off event, Δt is calculated (Step 534). Total Δt is incremented by the amount Δt (Step 536), The ON State flag is set to False (Step 538) and the process returns to Step 504 to update the data set and continue.

In the embodiment of FIG. 5, the following equations are used in reaching the final calculation:

$$Δ t = {t}_{off} - {t}_{on} ( computed for each pair of turn on and turn off events per 24 hour period )$$

$${t}_{consumed} = Total Δ t = ( the summation of the Δ ts for the 24 hour period )$$

$${BTU}_{day} = \sum ( {t}_{consumed} * \frac{Burning Rating Capacity}{hours * 60} )$$

$${ft}^{3} of gas = \frac{{BTU}_{day}}{Natural Gas Heating Value}$$

In connection with the above equations, Δt is the number of minutes between detected turn on and turn off events, estimating the time that the gas burner was actually on. Also, the Natural Gas Heating Value can be input as a specific value by the user (or utility) or a default of 1025 Btu/Ft³ can be used.

Unlike the algorithm depicted in FIG. 4, the algorithm of the embodiment of the invention depicted in FIG. 5 does not require the calculation of the first and second derivative values of the collected data. Additionally, however, one or more embodiments of the invention can include using both algorithms (or a combination of portions thereof) to take advantage of the strengths of each. By way of example, one embodiments of the invention can include using the start and stop times determined via the FIG. 5 algorithm and then use the first and second derivatives determined via the FIG. 4 algorithm. As noted herein, the algorithms can be executed completely by a sensor module and then sent to HEM for further processing and/or display, or portions of the data can be sent to the HEM for execution.

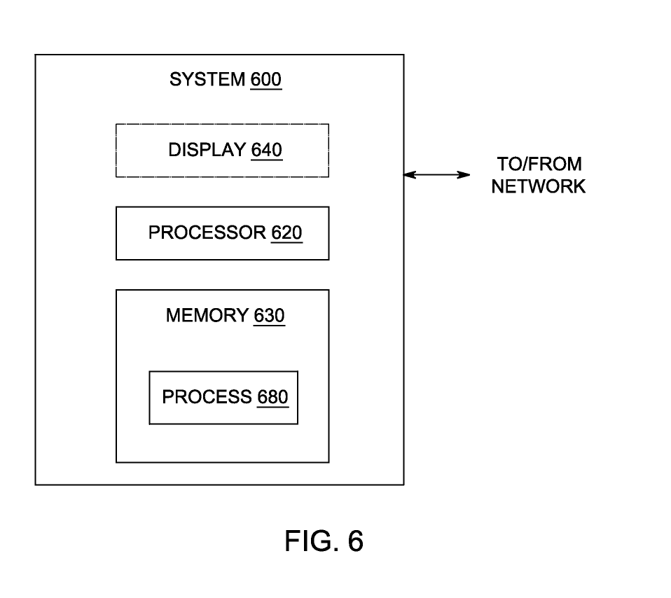

Aspects of the invention (for example, a workstation or other computer system to carry out design methodologies) can employ hardware and/or hardware and software aspects. Software includes but is not limited to firmware, resident software, microcode, etc. FIG. 6 is a block diagram of a system 600 that can implement part or all of one or more aspects or processes of the invention. As shown in FIG. 6, memory 630 configures the processor 620 to implement one or more aspects of the methods, steps, and functions disclosed herein (collectively, shown as process 680 in FIG. 6). Different method steps could theoretically be performed by different processors. The memory 630 could be distributed or local and the processor 620 could be distributed or singular. The memory 630 could be implemented as an electrical, magnetic or optical memory, or any combination of these or other types of storage devices. It should be noted that if distributed processors are employed (for example, in a design process), each distributed processor that makes up processor 620 generally contains its own addressable memory space. It should also be noted that some or all of computer system 600 can be incorporated into an application-specific or general-use integrated circuit. For example, one or more method steps (for example, those detailed herein) could be implemented in hardware in an application-specific integrated circuit (ASIC) rather than using firmware. Display 640 is representative of a variety of possible input/output devices.

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a processor or other computer system, to carry out all or some of the steps to perform the methods or create the apparatuses discussed herein. A computer-usable medium may, in general, be a recordable medium (for example, floppy disks, hard drives, compact disks, EEPROMs, or memory cards) or may be a transmission medium (for example, a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). As used herein, a tangible computer-readable recordable storage medium is intended to encompass a recordable medium, examples of which are set forth above, but is not intended to encompass a transmission medium or disembodied signal.

The computer system can contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention can make use of computer technology with appropriate instructions to implement method steps described herein.

Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

It will be understood that processors or computers employed in some aspects may or may not include a display, keyboard, or other input/output components. In some cases, an interface is provided.

Thus, while there have shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A sensor module apparatus comprising:
at least one transducer that obtains a measurement of one aspect of the combustion process of a gas-burning device; and
a microprocessor to calculate gas usage of the gas-burning device based on the measurement obtained by the at least one transducer.

2. The apparatus of claim 1, further comprising a radio frequency carrier to link the sensor module to a home energy management system to transmit the calculated gas usage to the home energy management system.

3. The apparatus of claim 1, further comprising a power line communication device within the module to link the sensor module to a home energy management system and transmit gas usage to the home energy management system.

4. The apparatus of claim 1, further comprising a memory component for storing data.

5. The apparatus of claim 1, further comprising a battery.

6. The apparatus of claim 5, further comprising a communication module operative to send information about battery voltage to a home energy manager to trigger an alert when the battery needs to be replaced.

7. The apparatus of claim 1, further comprising at least one of a power connection and an on-board power supply.

8. The apparatus of claim 1, further comprising a communications module enabling communication with a home energy manager via a hard-wired connection.

9. A sensor module apparatus comprising:
at least one transducer that obtains a measurement of one aspect of the combustion process of a gas-burning device; and
a radio frequency carrier to link the sensor module to a home energy management system to transmit the measurement of one aspect of the combustion process of a gas-burning device and a time stamp to the home energy management system to calculate gas usage of the gas-burning device based on the measurement obtained by the at least one transducer.

10. A method comprising the steps of:
calculating a running average of temperature data and corresponding time data for a component of a gas-burning device for a given timeframe;
calculating a first derivative of the running average data;
calculating a second derivative of the running average data;
identifying one or more peaks in the second derivative data;
identifying one or more valleys in the second derivative data;
using the first derivative data to select valley data points among the one or more identified valleys in the second derivative data;
subtracting the selected valley data point from the selected peak data point to determine an amount of time of gas usage; and
using the amount of time of gas usage to calculate a volume of gas used based on one or more parameters of the gas-burning device.

11. The method of claim 10, wherein a peak is a group of data points that is above a peak threshold value.

12. The method of claim 10, wherein a valley is a group of data points that is below a valley threshold value.

13. The method of claim 10, further comprising transmitting the calculated volume of gas used to a home energy manager.

14. The method of claim 10, further comprising transmitting one or more items of unexecuted data to a home energy manager.

15. The method of claim 10, wherein the gas-burning device comprises one of a furnace and a gas fueled clothes dryer.

16. The method of claim 10, wherein the gas-burning device comprises a hot water heater, and wherein the one or more parameters comprise at least one of burner rating capacity and gas heating value.

17. The method of claim 10, wherein using the first derivative data to select a valley data point among the one or more identified valleys in the second derivative data comprises using the first derivative valley data to identify a point to use in the second derivative valley data that represents a temperature fall due to gas being turned off.

18. A method comprising the steps of:
collecting temperature data and corresponding time data for a component of a gas-burning device;
analyzing the temperature data to determine a time at which the gas-burning device begins burning gas and a time at which the gas-burning device ends burning gas;
calculating a time duration of gas consumption by the gas-burning device based on the time at which the gas-burning device begins burning gas and the time at which the gas-burning device ends burning gas;
calculating an amount of energy used during the calculated time duration of gas consumption based on the time duration and one or more parameters of the gas-burning device; and
calculating a volume of gas used during the time duration of gas consumption based on the calculated amount of energy used and one or more parameters of the gas-burning device.

19. The method of claim 18, wherein analyzing the temperature data to determine a time at which the gas-burning device begins burning gas and a time at which the gas-burning device ends burning gas comprises determining whether the temperature data satisfies one or more pre-defined conditions.

20. The method of claim 18, wherein the gas-burning device comprises a hot water heater, and wherein the one or more parameters comprise at least one of burner rating capacity and gas heating value.

21. A system for determining burner duration of an appliance having a gas burner, the system comprising:
a temperature sensor responsive to temperature of a structure of the appliance heated by the gas burner; and
a processor coupled to a memory, and operatively connected to the temperature sensor to receive and store temperature data from the sensor and process the data to detect turning on of the gas burner and turning off of the gas burner and to determine a duration of time between the turning on and turning off of the burner.

22. The system of claim 21, wherein the processor is further operative to determine an amount of gas consumed by the burner as a function of the duration of time that the burner was on.

23. The system of claim 21, wherein the processor is operative to identify the turning on times and the turning off times of the burner using first and second derivatives of the temperature data.

24. The system of claim 21, wherein the processor is operative to identify the turning on times and turning off times of the burner using a slope of the temperature data as a function of time.

25. A method for determining gas consumed by an appliance having a gas burner, the method comprising:
identifying turning on times of the burner;
identifying turning off times of the burner;
determining a burner duration of time the burner is on time by determining a time lapse between the turning on time and the turning off time; and
calculating an amount of gas consumed as a function of the duration of time the burner is on.
